(19) United States
(12) Patent Application Publication
(10) Pub. No.: US 2020/0178663 A1
(43) Pub. Date: Jun. 11, 2020

(54) MODULAR ORGANIZER

(71) Applicant: Frank Vogel LLC, Boulder, CO (US)

(72) Inventor: Frank Vogel, Boulder, CO (US)

(21) Appl. No.: 16/216,418

(22) Filed: Dec. 11, 2018

(51) Int. Cl. A45C 11/32; E05B 19/00

(52) U.S. Cl. CPC A45C 11/324; A47G 29/10; E05B 19/00

(57) ABSTRACT

An organizer includes a body adapted to receive and hold a head of a tool and a joining feature provided to the body. The joining feature is adapted to allow interconnection of two or more bodies and includes a complementary protrusion and socket arrangement configured to pivotally couple together by a push fit arrangement of the protrusion from a first body into a socket of a second body. The organizer may further include means for biasing two adjacent, coupled bodies in a pre-established relative orientation.

### TECHNICAL FIELD

The present disclosure relates to organizing of tools.

### SUMMARY

The disclosure seeks to describe a key organizing system including a jacket adapted to receive a head of a key, a joining mechanism configured to pivotably couple the jacket to one or more other jackets about a pivot axis and a first magnet provided at the jacket, offset from the pivot axis.

Further, the disclosure seeks to describe a key management system, including a jacket adapted to receive a head of a key, a joining mechanism configured to pivotably couple the jacket to one or more other jackets about a pivot axis and an orienting mechanism configured to bias the jacket into a pre-established orientation about the pivot axis relative to another pivotably coupled jacket.

Still further, the disclosure seeks to describe a modular organizer including a body adapted to receive and hold a head of a tool and a joining feature provided to the body. The joining feature is adapted to allow interconnection of two or more bodies and includes a complementary protrusion and socket arrangement configured to pivotally couple together by a push fit arrangement of the protrusion from a first body into the socket of a second body, wherein the protrusion comprises at least one relief slot.

### BRIEF DESCRIPTION OF THE FIGURES

The summary above, as well as the following detailed description of illustrative embodiments, is better understood when read in conjunction with the appended figures. For the purpose of illustrating the disclosure, example constructions are shown in the figures. However, the disclosure is not limited to specific methods and instrumentalities disclosed herein. Moreover, those having ordinary skill in the art will understand that the figures are not to scale. Wherever possible, like elements have been indicated by identical numbers.

Embodiments of the disclosure will now be described, by way of example only, with reference to the following diagrams wherein:

FIG. 1 illustrates a front view of an example jacket suitable for use with disclosed key management systems.

FIG. 2 illustrates a bottom view of the example jacket of FIG. 1.

FIG. 3 illustrates a top view of the example jacket of FIGS. 1 & 2.

FIG. 4 illustrates a right-side view of the example jacket of FIGS. 1-3.

FIG. 5 illustrates a rear view of the example jacket of FIGS. 1-4.

FIG. 6 illustrates a front view of an example jacket with an example key.

FIG. 7 illustrates a bottom view of the example jacket and example key of FIG. 6.

FIG. 8 illustrates a top view of the example jacket and example key of FIGS. 6 & 7.

FIG. 9 illustrates a right-side view of the example jacket and example key of FIGS. 6-8.

FIG. 10 illustrates a rear view of the example jacket and example key of FIGS. 6-9.

FIG. 11A illustrates a front perspective view of an example key management system with two example disengaged or uncoupled keys held in two jackets and a close-up view of an example protrusion 142.

FIG. 11B illustrates a rear perspective view of an example key management system with two example disengaged or uncoupled keys held in two jackets and a close-up view of an example socket 146.

FIG. 12A illustrates a front perspective view of an example key management system with two example engaged or coupled keys held in two jackets and a close-up view of an example protrusion 142.

FIG. 12B illustrates a rear perspective view of an example key management system with two example engaged or coupled keys held in two jackets and a close-up view of an example socket 146.

FIG. 13 illustrates a perspective view of an example key management system with two example keys held in two jackets.

FIG. 14 illustrates a front view of the example key management system of FIG. 11.

FIG. 14A illustrates a left sectional view of the example key management system of FIG. 14 along the line A-A.

FIG. 14B illustrates a close-up view of the section of FIG. 14B.

FIG. 15 illustrates a front view of an example key management system with two example keys held in two jackets and offset to an example pre-established relative orientation.

FIG. 16 illustrates a rear view of an example key management system with two example keys held in two jackets and offset to an intermediate orientation.

### DETAILED DESCRIPTION

The following detailed description illustrates embodiments of the disclosure and manners by which they can be implemented. Although the best mode of carrying out disclosed systems, methods and apparatuses has been described, those of ordinary skill in the art would recognize that other embodiments for carrying out or practicing disclosed systems, methods and apparatuses are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Small tools such as keys are kept together in a single bundle for convenient organization. Unfortunately, devices available for this purpose are of a design which makes adding tools thereto or removing tools therefrom difficult. Further, while such devices keep several small tools together, they still allow for a number of unnecessary degrees of freedom allowing organized tools to become jumbled and disorganized.

Embodiments of the disclosure provide a key management system, modular organizer and/or key organizer. The key management system includes a body in the form of a jacket, envelope, sleeve, folder or pocket adapted to receive a head of a key. A joining mechanism is configured to pivotably couple the body to one or more other bodies about a pivot axis.

Additionally, an orienting mechanism is configured to bias the body into a pre-established orientation about the pivot axis relative to another pivotably coupled body.

Embodiments of the disclosure substantially eliminate, or at least partially address, problems in the prior art, enabling use of one or more of several tools while the several tools are organized into a single, easily handled and transported tool cluster. A convenient joining mechanism allows for one or more of the several tools to be separated from the cluster, if desired. For example, a user may want to loan the tool to another user or may want to reorder or otherwise reorganize the tool cluster.

Additional aspects, advantages, features and objects of the disclosure will be made apparent from the figures and the detailed description of the illustrative embodiments construed in conjunction with the appended claims that follow.

It will be appreciated that described features are susceptible to being combined in various combinations without departing from the scope of the disclosure as defined by the appended claims.

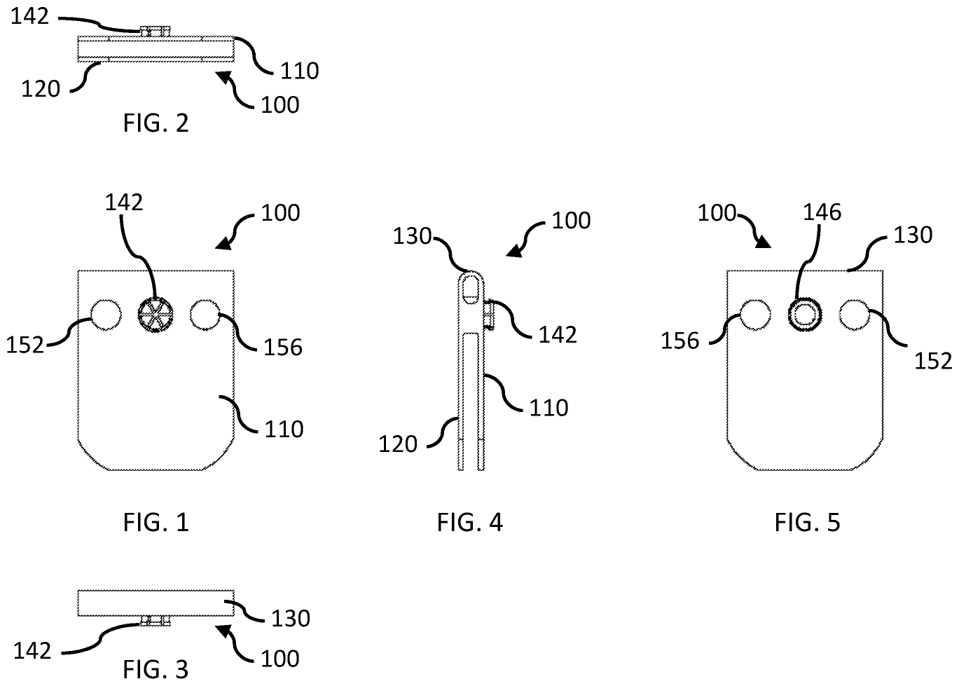

FIGS. 1-5 illustrate an example jacket suitable for use with disclosed modular organizers, key management systems and/or key organizers.

Key organizing systems, modular organizers and/or key management systems include a body or jacket 100 adapted to receive and hold a head of a key. A joining feature or mechanism 142 and 146 is provided to the jacket.

In an example, jacket 100 includes a plank, plate or planar prong 110 configured to abut an exterior planar surface of a head of a key with the head received in jacket 100. A second plank, plate or planar prong 120 opposes planar prong 110 to grip the head of a key placed therebetween. Spine 130 joins second planar prong 120 to first planar prong 110.

While planar prongs 110 and 120 and spine 130 may be provided in any of a variety of shapes and dimensions substantially matched to the head of a tool to be held in jacket 100, in an example, planar prongs 110 and 120 are approximately 25 mm wide and approximately 30 mm long while spine 130 is approximately 2 mm thick. Jacket 100 including planar prongs 110 and 120 and spine 130 may be formed of any of a variety of materials including but not limited to plastic, metal or wood.

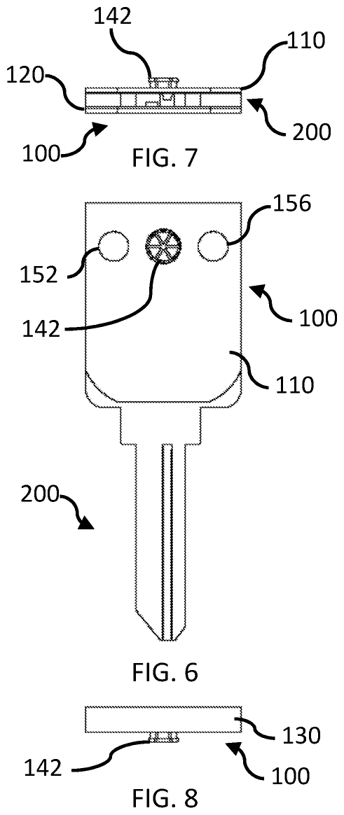

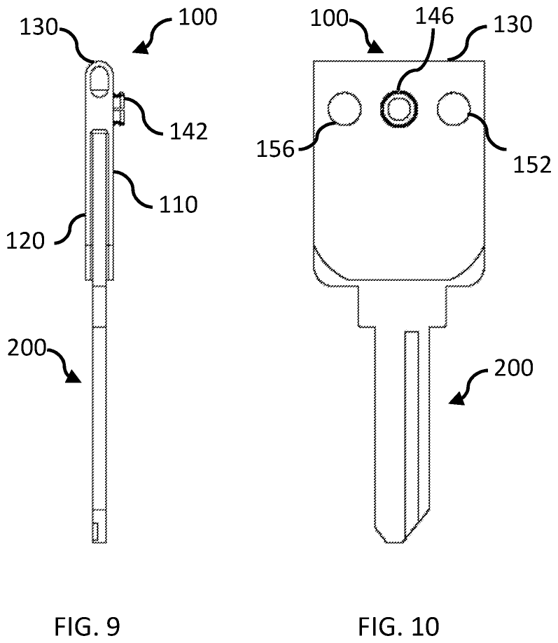

adhesive may be provided to an interior of jacket 100 so as to secure jacket 100 to the head of a tool. FIGS. 6-10 illustrates an example jacket with an example key held therein.

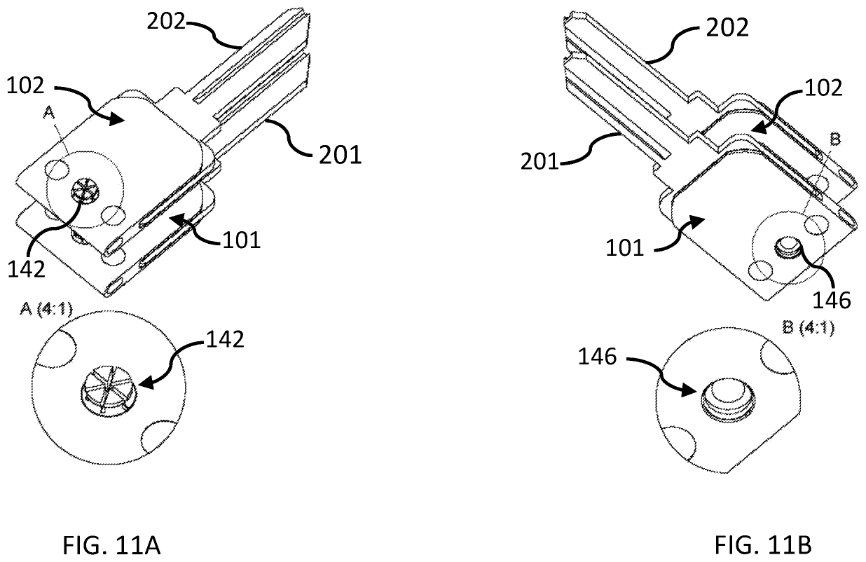

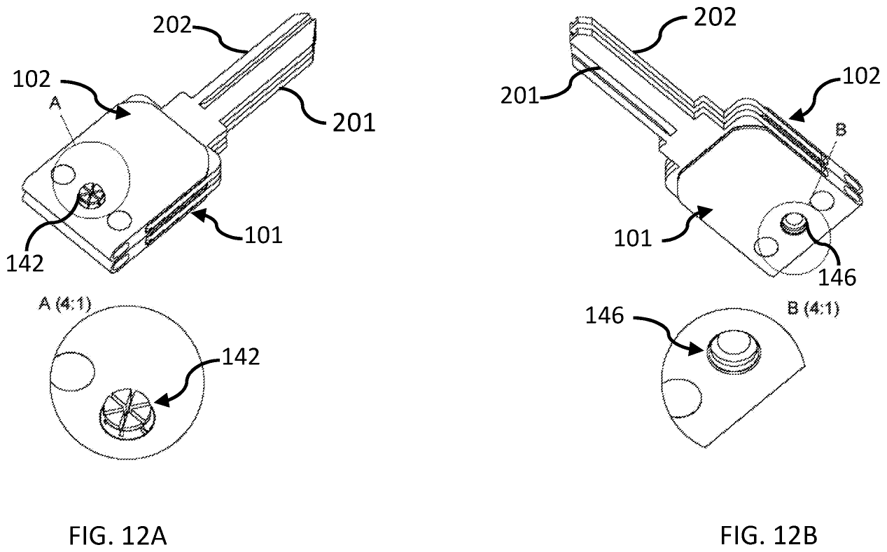

Referring to FIGS. 11-13, the joining mechanism 142 and 146 is adapted to allow interconnection of two or more jackets 100 and includes a complementary protrusion 142 and socket 146 arrangement configured for pivotal coupling by a push or press fit arrangement of a protrusion 142 from a first jacket 101 into a socket 146 of a second jacket 102. In an example, both disclosed components of the joining mechanism may be the result of the same manufacturing actions. In such an example, it may be said that the joining mechanism includes a socket 146 formed within a protrusion 142 or that the joining mechanism includes a protrusion 142 formed around a socket 146.

An example joining mechanism 142 and 146 is configured to pivotably couple jacket 100 to one or more other jackets 100 about a pivot axis normal to the jacket planar surface while resisting pivoting of jacket 100 relative to another pivotably coupled jacket 100 about other axes including those parallel with the surfaces of planar prongs 110 and 120.

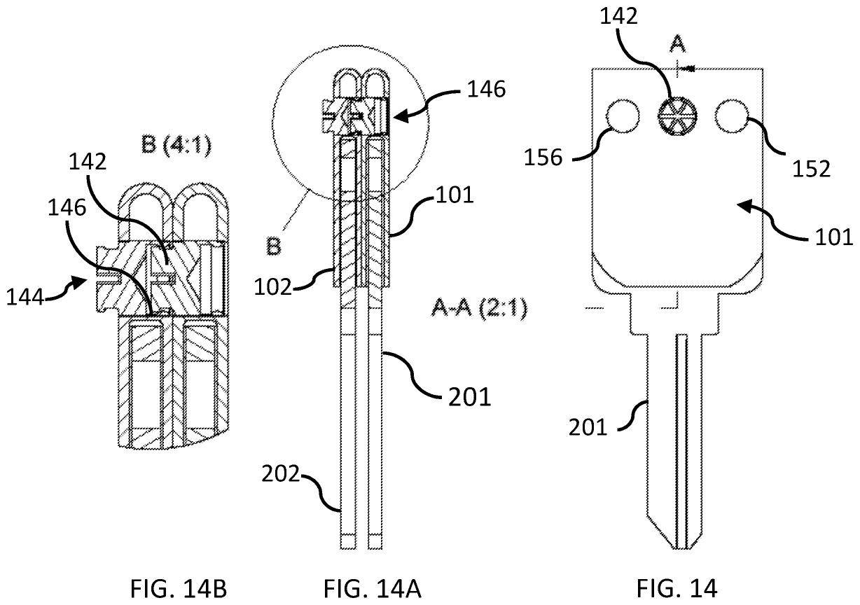

Referring to FIGS. 14, 14A and 14B, one or more relief slots 144 may be provided to joining mechanism 142 and 146. In an example, the relief slots intersect at a center point of the protrusion 142 and/or the socket 146. In another example, the ability of protrusion 142 to compress or flex inward towards its center is enabled by one or more alternatives to slots 144 such as one more properties of the material from which protrusion 142 and socket 146 are formed.

The organizer may further include an orienting mechanism or means 152 and 156 for biasing two adjacent, coupled jackets 100 in a pre-established relative orientation. The pre-established orientation may be defined by an angle of pivot between jacket 100 and another pivotably coupled jacket 100 about the pivot axis.

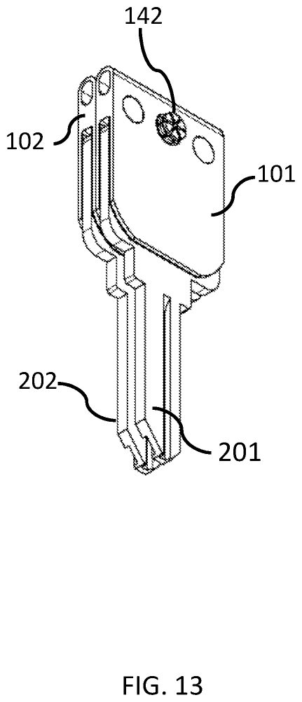

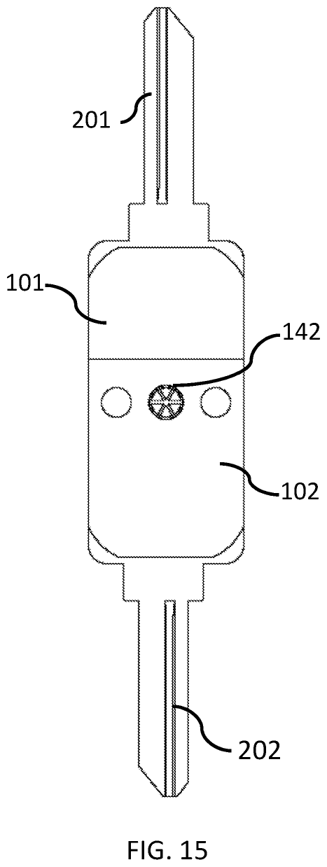

Orienting mechanism 152 and 156 may be configured to bias jacket 100 into any of several orientations. For example, orienting mechanism 152 and 156 may be configured to bias a jacket 100 into a first orientation wherein jacket 101 is aligned with another jacket 102 coupled therewith as shown by way of example in FIGS. 13 & 14. The orienting mechanism may additionally or alternatively be configured to bias a jacket 100 into a second orientation pivoted 180 degrees from the first orientation as shown by way of example in FIG. 15. This second orientation 180 degrees from the first orientation may be considered a fully-open orientation or, since key shafts project in opposite directions, an opposed orientation.

In an example, the orienting mechanism for biasing two adjacent, coupled jackets in one or more pre-established relative orientations is further configured to encourage, compel, propel, cause or otherwise influence the pivotably coupled jackets to pivot to the pre-established orientation for example, once a threshold pivot angle has been exceeded.

In a further example, the orienting mechanism or means for biasing includes a first magnet 152 provided at jacket 100, offset from the pivot axis. The orienting mechanism or means for biasing may further include a second magnet 156 offset from the pivot axis opposite first magnet 152 with first magnet 152, the pivot axis and second magnet 156 aligned along a width of a jacket. In an example, first magnet 152 and second magnet 156 each have first and second poles, the first poles are aligned and the second poles are aligned.

The number of magnets, the position of the magnets and combinations of these may be adjusted to change the number of pre-established orientations to which coupled jackets 100 may be biased. For example, a single off-center magnet may be configured to bias coupled jackets toward a single pre-established orientation such as completely aligned or completely opposed.

In another embodiment, a key management system may be provided without the example jackets of FIGS. 1-16. For example, a key management system may include a key shaft, a key head connected with the key shaft and having a planar surface and a joining mechanism configured to pivotably couple the key head to one or more other key heads about a pivot axis normal to the planar surface and an orienting mechanism configured to bias the key head into a pre-established orientation about the pivot axis relative to another pivotably coupled key head.

The orienting mechanism may include a first magnet provided to the key head, offset from the pivot axis and a second magnet offset from the pivot axis opposite the first magnet.

The first and second magnets, which have first and second poles which are aligned, are configured to bias the key head into one or more pre-established orientations relative to another key head coupled therewith.

For example, the first and second magnets are configured to bias the key head into either of a first orientation wherein the key head is aligned with another key head coupled therewith and a second orientation pivoted 180 degrees from the first orientation.

The joining mechanism may include a protrusion and a socket formed within the protrusion. Alternatively, the joining mechanism may include a socket and a protrusion formed around the socket.

The protrusion may include one or more relief slots which may intersect at a center point of the protrusion.

The joining mechanism and the magnets may be provided such that centers are aligned along a width of the jackets.

A user may organize a number of tools according to a tool organizing method. An example tool organizing method includes receiving a head of a key in a jacket (FIGS. 6-10) and coupling the jacket to one or more other jackets with a joining mechanism such that jackets are relatively pivotable about a pivot axis (FIGS. 11-16).

A key head may be placed into contact with either of planar prong 110 or planar prong 120 and then the other prong pivoted into contact with the key head about spine 130 in a hinge-type relationship. Alternatively, the key head may be slid between a parallel arrangement of planar prongs 110 and 120 until it reaches a position contacting spine 130.

One or more jackets may be pivotably coupled by first inserting a protrusion of one jacket into a socket of another jacket thereby causing the protrusion to compress inward due to one or more relief slots therein or due to a material property allowing for inward flexion of the protrusion and subsequent expansion back to the initial shape. Once the protrusion has been fully inserted into the socket, the protrusion expands and an enlarged cross section of the protrusion engages with an enlarged cross section of the socket (FIG. 14B) to releasably hold together first and second jackets and any keys held thereby. Remaining sockets may be engaged with protrusions of additional jackets and/or remaining protrusions may engage a socket of an additional jacket to manage additional keys.

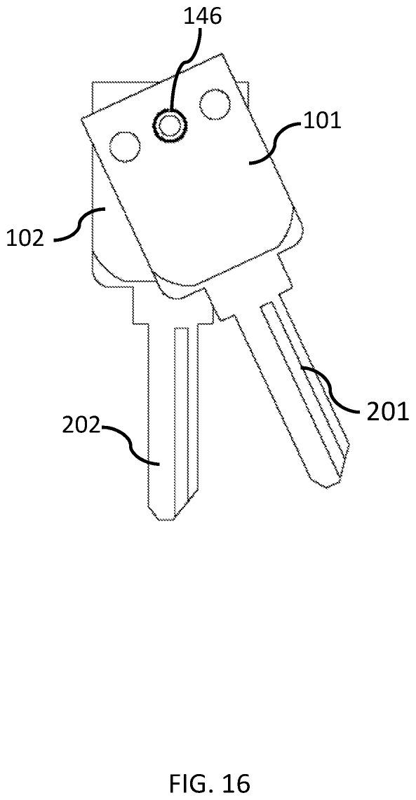

Jackets coupled by the joining mechanism are biased into one or more pre-established orientations relative one another by an orienting mechanism. First and second magnets may bias coupled jackets into the pre-established relative orientations. If the jackets and the keys held thereby are not in an aligned orientation but are offset from the aligned orientation by less than a threshold aligned offset angle, for example as shown in FIG. 16, the first and second magnets cause or are configured to cause relative pivoting of pivotably coupled jackets to the pre-established aligned orientation (FIGS. 13 & 14).

Alternatively, If the jackets and the keys held thereby are in neither an aligned orientation nor an opposed orientation but are offset from the opposed orientation by less than a threshold opposed offset angle, the first and second magnets cause or are configured to cause relative pivoting of pivotably coupled jackets to the pre-established opposed orientation (FIG. 15).

When a user having two or more keys assembled, is storing the keys, for example, in a pocket or bag, each pair of jacketed keys may be relatively pivoted close to the aligned orientation (FIG. 16) such that the first magnets of two jackets are attracted and second magnets of two jackets are attracted. The pairs of jacketed keys snap to the aligned orientation (FIGS. 13 & 14) under the attractive power of the magnets.

When a user having two or more keys assembled, requires using one of the keys, the key may be pivoted out of alignment with the adjacent keys close to the opposed orientation such that the first magnet of one jacket is attracted to the second magnet of a second jacket and the second magnet of one jacket is attracted to the first magnet of the second jacket. Under the attractive power of the magnets, the jacketed key snaps to the opposed orientation (FIG. 15) where the key shaft is available for unobstructed insertion into a lock.

The assembly may then be reconfigured such that the used key back returns to the aligned orientation (FIGS. 13 & 14) relative to the other jacketed keys.

Actions described above with reference to the example key organizing method are only illustrative and other alternatives can also be provided where one or more actions are added, one or more actions are removed, or one or more actions are provided in a different sequence without departing from the scope of the claims herein.

While organizers, systems and methods of the disclosure have generally been described by way of example as suitable for use with keys, it should be noted that the organizers, systems and methods may be suitable for use with a variety of tools including but not limited to mechanical tools such as wrenches, screwdrivers, awls, and chisels as well as electronic devices such as flash drive memory devices, universal serial bus dongles or systems on chips. Embodiments of the disclosure are susceptible to being used for various purposes, including, though not limited to, enabling users to manage several tools in a modular scheme such that managed tools are separable and reconfigurable.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim disclosed features are intended to be construed in a non-exclusive manner, namely allowing for items, components or elements not explicitly described also to be present. Reference to the singular is also to be construed to relate to the plural.

What is claimed is:

1. A key organizing system, comprising:
a jacket adapted to receive a head of a key;
a joining mechanism configured to pivotably couple the jacket to one or more other jackets about a pivot axis; and
a first magnet provided at the jacket, offset from the pivot axis.

2. The system as set forth in claim 1, wherein the first magnet is configured to bias the jacket into one or more pre-established orientations relative to another jacket coupled therewith by the joining mechanism.

3. The system as set forth in claim 1, wherein the joining mechanism further comprises a protrusion.

4. The system as set forth in claim 3, wherein the joining mechanism further comprises a socket formed within the protrusion.

5. The system as set forth in claim 1, wherein the joining mechanism further comprises a socket.

6. The system as set forth in claim 5, wherein the joining mechanism further comprises a protrusion formed around the socket.

7. The system as set forth in claim 1, further comprising a second magnet offset from the pivot axis opposite the first magnet.

8. The system as set forth in claim 7, wherein the first and second magnets each have first and second poles and wherein the first poles are aligned.

9. The system as set forth in claim 7, wherein the first and second magnets are configured to bias the jacket into one or more pre-established orientations relative to another jacket coupled therewith by the joining mechanism.

10. The system as set forth in claim 7, wherein the first and second magnets are configured to bias the jacket into either of a first orientation wherein the jacket is aligned with another jacket coupled therewith or a second orientation pivoted substantially 180 degrees from the first orientation.

11. A key management system, comprising:
a jacket adapted to receive a head of a key;
a joining mechanism configured to pivotably couple the jacket to one or more other jackets about a pivot axis; and
an orienting mechanism configured to bias the jacket into a pre-established orientation about the pivot axis relative to another pivotably coupled jacket.

12. The system as set forth in claim 11, wherein the jacket includes a planar prong configured to abut a planar surface of the head with the head received in the jacket and the joining mechanism is configured resist pivoting of the jacket relative to another pivotably coupled jacket about axes parallel with the jacket planar surface.

13. The system as set forth in claim 11, wherein the pre-established orientation exhibits an angle of pivot between the jacket and another pivotably coupled jacket about the pivot axis.

14. The system as set forth in claim 11, wherein the orienting mechanism is configured to cause pivoting of the jacket to the pre-established orientation relative to the other pivotably coupled jacket once a threshold pivot angle has been exceeded.

15. A modular organizer comprising:
a body adapted to receive and hold a head of a tool; and
a joining feature provided to the body, adapted to allow interconnection of two or more bodies and including a complementary protrusion and socket arrangement configured to pivotally couple together by a push fit arrangement of the protrusion from a first body into a socket of a second body, wherein the protrusion comprises at least one relief slot.

16. The modular organizer as set forth in claim 15, wherein the at least one relief slot further comprises a plurality of relief slots.

17. The modular organizer as set forth in claim 16, wherein the plurality of relief slots intersect at a center point of the protrusion.

18. The modular organizer as set forth in claim 15, further comprising means for biasing two adjacent, coupled bodies in a pre-established relative orientation.

19. The modular organizer as set forth in claim 18, wherein the means for biasing two adjacent, coupled bodies in a pre-established relative orientation is configured to cause the bodies to pivot to the pre-established orientation.

20. The modular organizer as set forth in claim 18, wherein the means for biasing two adjacent, coupled bodies in a pre-established relative orientation is configured to cause the bodies to pivot to the pre-established orientation once a threshold pivot angle has been exceeded.
